(19) United States
(12) Patent Application Publication
(10) Pub. No.: US 2024/0286416 A1
(43) Pub. Date: Aug. 29, 2024

(54) THERMAL PRINT HEAD

(71) Applicant: ROHM CO., LTD., KYOTO-SHI (JP)

(72) Inventors: YASUYUKI ARITAKI, KYOTO-SHI (JP); TOSHIO WATANABE, KYOTO-SHI (JP); KAZUYA NAKAKUBO, KYOTO-SHI (JP); TAKAMICHI OTANI, KYOTO-SHI (JP)

(21) Appl. No.: 18/444,063

(22) Filed: Feb. 16, 2024

(30) Foreign Application Priority Data
Feb. 24, 2023 (JP) 2023-026920

(51) Int. Cl. B41J 2/335

(52) U.S. Cl. CPC B41J 2/3351; B41J 2/3355; B41J 2/33515

(57) ABSTRACT

The present disclosure provides a thermal print head. The thermal print head includes: a substrate; a glaze layer, disposed on the substrate; and a wiring layer, disposed on the glaze layer. The wiring layer includes a plurality of bonding pads. The plurality of bonding pads are divided into a plurality of groups. Each of the plurality of groups includes a first bonding pad, a second bonding pad, a third bonding pad and a fourth bonding pad. A first group of the plurality of groups is adjacent to a second group of the plurality of groups along a first direction. The second bonding pad of the first group is located between a center of the first bonding pad of the first group and a center of the third bonding pad of the first group along the first direction.

### TECHNICAL FIELD

The present disclosure relates to a thermal print head.

### BACKGROUND

For example, the Japanese Patent Publication No. 2019-98667 (patent publication 1) discloses a thermal print head. The thermal print head disclosed in patent document 1 includes a substrate, a glaze layer and a wiring layer. The glaze layer is disposed on the substrate. The wiring layer is disposed on the glaze layer.

The wiring layer includes a plurality of first bonding pads and a plurality of second bonding pads. The plurality of first bonding pads are arranged along a first direction to form one row. The plurality of second bonding pads are arranged along the first direction to form one row. The row of the first bonding pads is located on a position shifted from the row of the second bonding pads in a second direction. The second direction is a direction perpendicular to the first direction. A lead wiring portion extends from the first bonding pads and the second bonding pads along the second direction.

### PRIOR ART DOCUMENT

### Patent Publication

[Patent document 1] Japan Patent Publication No. 2019-98667

### BRIEF DESCRIPTION OF THE DRAWINGS

FIG. 1 is a cross-sectional view of a thermal print head 100.

FIG. 2 is a cross-sectional view along a section line II-II in FIG. 1.

FIG. 3 is a cross-sectional view along a section line III-III in FIG. 1.

FIG. 4 is a cross-sectional view along a section line IV-IV in FIG. 1.

FIG. 5 is an enlarged partial view of FIG. 1.

FIG. 6 is manufacturing steps of the thermal print head 100.

FIG. 7 is a cross-sectional view of glaze layer forming step S2.

FIG. 8 is a cross-sectional view of metal layer forming step S3.

FIG. 9 is a cross-sectional view of metal layer patterning step S4.

FIG. 10 is a cross-sectional view of heat generator forming step S5.

FIG. 11 is a cross-sectional view of protection glass forming step S6.

FIG. 12 is an enlarged plan view of a thermal print head 100A.

### DETAILED DESCRIPTION OF THE EMBODIMENTS

Details of the embodiments of the present disclosure are given with the accompanying drawings below. The same or equivalent parts are denoted by the same numerals or symbols in the accompanying drawings below, and the repeated description is omitted. A thermal print head of the embodiment is set to configured to be a thermal print head 100.

### (Configuration of Thermal Print Head 100)

The configuration of the thermal print head 100 is described below.

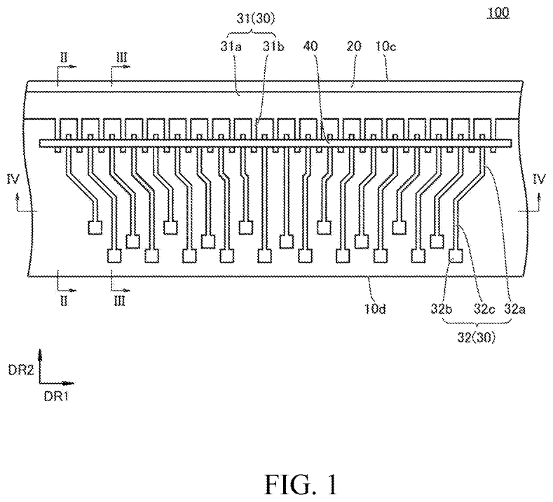

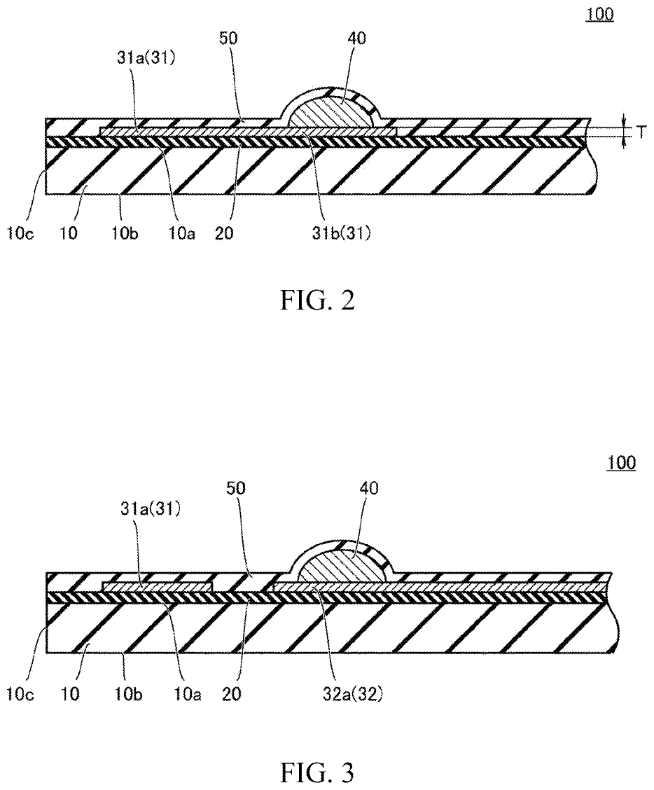

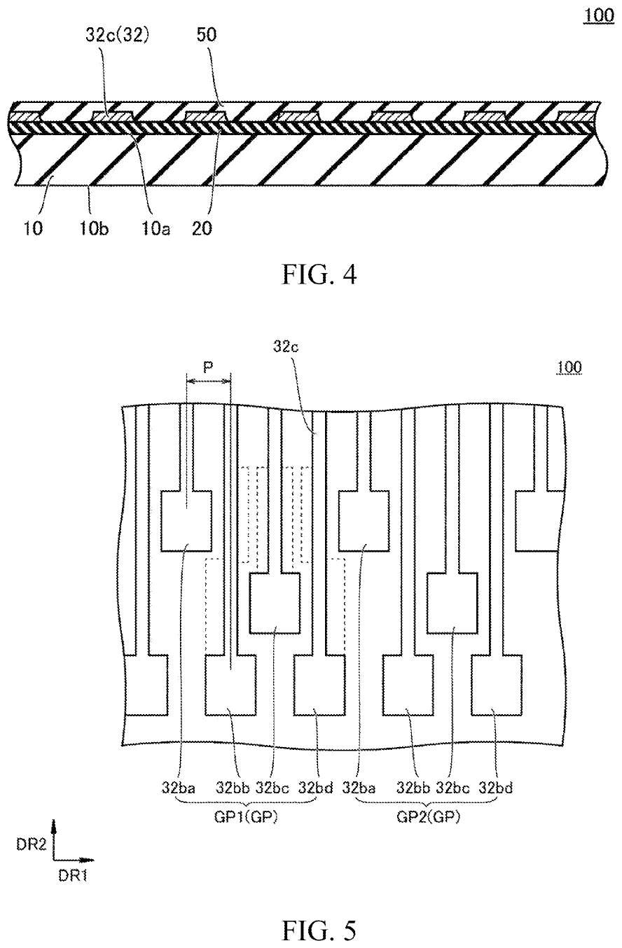

FIG. 1 shows a cross-sectional view of the thermal print head 100. In FIG. 1, the drawing of a protection glass 50 is omitted. FIG. 2 shows a cross-sectional view along a section line II-II in FIG. 1. FIG. 3 shows a cross-sectional view along a section line III-III in FIG. 1. FIG. 4 shows a cross-sectional view along a section line IV-IV in FIG. 1. FIG. 5 shows an enlarged partial view of FIG. 1. As shown in FIG. 1 to FIG. 5, the thermal print head 100 includes a substrate 10, a glaze layer 20, a wiring layer 30, a heat generator 40 and a protection glass 50.

The substrate 10 has a first main surface 10a and a second main surface 10b. The first main surface 10a and the second main surface 10b are end surfaces of the substrate 10 in the thickness direction. The second main surface 10b is a surface opposite to the first main surface 10a. In a plan view (observed from the side of the first main surface 10a along a normal direction of the first main surface 10a), a lengthwise direction of the substrate 10 is set as a first direction DR1. A direction perpendicular to the first direction DR1 in the plan view is set as a second direction DR2. Two ends of the substrate 10 in the second direction DR2 are respectively set as a first end 10c and a second end 10d.

The substrate 10 is formed of an insulating material. The substrate 10 is formed of, for example, ceramic. A material forming the substrate 10 is specifically, for example, aluminum oxide (Al₂O₃).

The glaze layer 20 is disposed on the substrate 10. More specifically, the glaze layer 20 is disposed on the first main surface 10a. The glaze layer 20 is formed of an insulating material. A material forming the glaze layer 20 is specifically, for example, glass.

The wiring layer 30 is disposed on the glaze layer 20. The wiring layer 30 includes a common electrode 31 and a plurality of individual electrodes 32.

The common electrode 31 includes a body 31a and a plurality of protrusions 31b. The body 31a extends along the first direction DR1. The body 31a is located on the side of the first end 10c in the second direction DR2. That is to say, a distance between the first end 10c and the body 31a in the second direction DR2 is less than a distance between the second end 10d and the body 31a in the second direction DR2.

The protrusions 31b protrude from an edge of the body 31a facing the side of the second end 10d along the second direction DR2. The plurality of protrusions 31b are arranged at intervals along the first direction DR1.

Each of the individual electrodes 32 includes a front end 32a on one end portion and a bonding pad 32b on the other end portion. The front end 32a is disposed between two adjacent protrusions 31b. That is to say, the protrusions 31b and the front ends 32a are alternately arranged in the first direction DR1. The front end 32a extends along the second direction DR2.

The plurality of bonding pads 32b are divided into a plurality of groups GP. Each GP includes a first bonding pad 32ba, a second bonding pad 32bb, a third bonding pad 32bc and a fourth bonding pad 32bd. A first group of the plurality of groups GP is set as a first group GP1. Another group of the plurality of groups GP that is adjacent to the first group GP1 in the first direction DR1 is set as a second group GP2.

The second bonding pad 32bb of the first group GP1 is located between a center of the first bonding pad 32ba of the first group GP1 and a center of the third bonding pad 32bc of the first group GP1 along the first direction DR1. The fourth bonding pad 32bd of the first group GP1 is located between the center of the third bonding pad 32bc of the first group GP1 and a center of the first bonding pad 32ba of the second group GP2 along the first direction DR1. From another perspective, the first bonding pad 32ba, the second bonding pad 32bb, the third bonding pad 32bc and the fourth bonding pad 32bd are sequentially arranged along the first direction DR1.

The third bonding pad 32bc is disposed between the first bonding pad 32ba and the fourth bonding pad 32bd and also between the second bonding pad 32bb and the fourth bonding pad 32bd in the second direction DR2. From another perspective, the plurality of first bonding pads 32ba are arranged to form one row (a first row) along the first direction DR1, the plurality of third bonding pads 32bc are arranged to form one row (a second row) along the first direction DR1, and the plurality of second bonding pads 32bb and the plurality of fourth bonding pads 32bd are arranged to form one row (a third row) along the first direction DR1. Moreover, the first row, the second row and the third row are arranged on positions shifted from one another in the second direction DR2.

The front end 32a and the bonding pad 32b are connected by a lead wiring portion 32c. The part of the lead wiring portion 32c connected to the bonding pad 32b extends from the bonding pad 32b along the second direction DR2.

A pitch P between two adjacent bonding pads 32b is set as a pitch P. The pitch P is a distance between a center of one bonding pad 32b in the first direction DR1 and a center of another bonding pad 32b adjacent to the one bonding pad 32b in the first direction DR1. The pitch P is preferably less than about 70 μm. The pitch P can also be less than about 60 μm. The pitch P is, for example, more than about 30 μm.

A thickness of the wiring layer 30 is set as a thickness T. The thickness T is preferably more than about 3 μm. The thickness T can also be more than about 4 μm. The thickness T is, for example, less than about 10 μm. The wiring layer 30 is formed of, for example, a material including silver (Ag). A material forming the wiring layer 30 is specifically, for example, a sintered body of silver particles. The material forming the wiring layer 30 can include copper (Cu) or can include gold (Au).

The heat generator 40 extends long the first direction DR1. The heat generator 40 is disposed on the glaze layer 20 while overlapping the protrusion 31b and the front end 32a. The heat generator 40 includes, for example, glass, and a plurality of conductive particles blended into the glass. The conductive particles are formed of, for example, ruthenium oxide (RuO₂).

A common potential (for example, a ground potential) is applied to the common electrode 31. Although not shown, the bonding pad 32b is electrically connected to an external terminal (a bonding pad) of a driver integrated circuit (IC) by a bonding wire. Thus, a potential is selectively applied to each of the plurality of individual electrodes 32 by the driver IC. Thus, a current flow through the part of generator 40 between the front end 32a of the independent electrode 32 applied with the potential and the adjacent protrusion 31b, and the part resistively generates heat. Printing on paper is performed by transferring to the heat to the paper.

The protection glass 50 is disposed on the glaze layer 20 to cover the wiring layer 30 and the heat generator 40. Although not shown, the protection glass 50 has an opening portion, and the bonding pad 32b is exposed from the opening portion.

### (Method for Manufacturing Thermal Print Head 100)

The method for manufacturing the thermal print head 100 is described below.

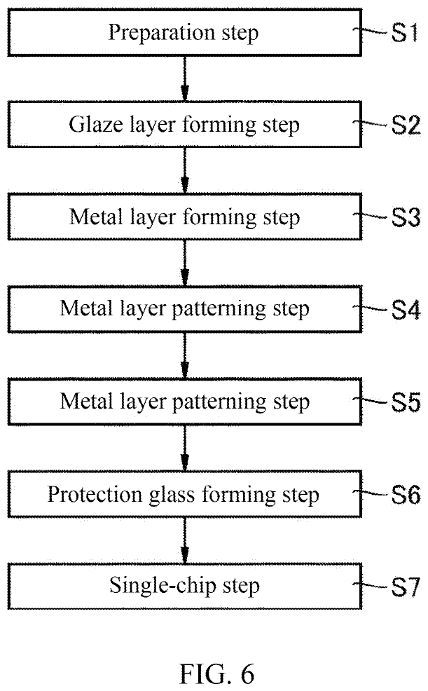

FIG. 6 shows manufacturing steps of the thermal print head 100. As shown in FIG. 6, the method for manufacturing the thermal print head 100 includes preparation step S1, glaze layer forming step S2, metal layer forming step S3, metal layer patterning step S4, heat generator forming step S5, protection glass forming step S6, and single-chip step S7.

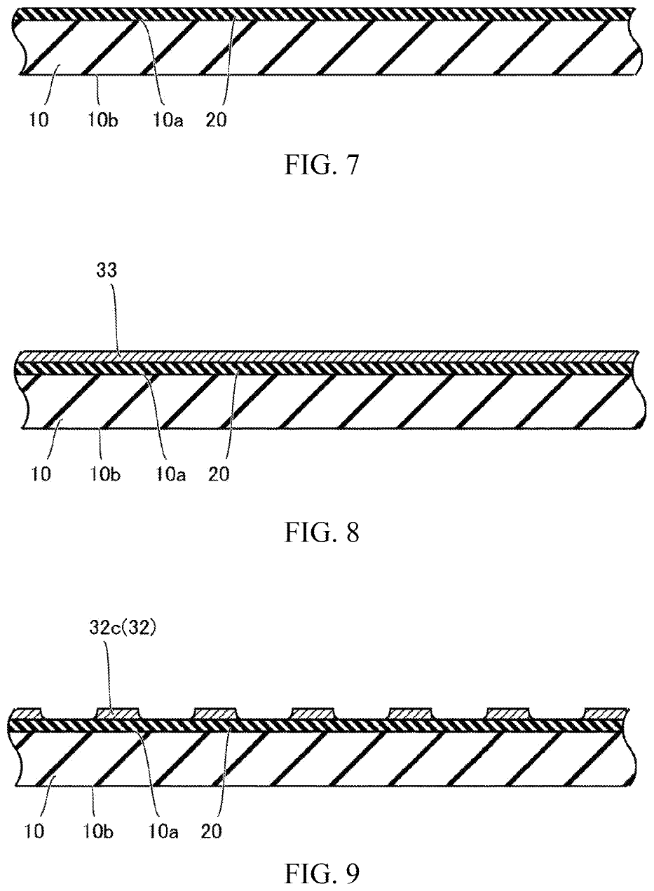

In the preparation step S1, the substrate 10 is prepared. The glaze layer forming step S2 is performed after the preparation step S1. FIG. 7 shows a cross-sectional view of the glaze layer forming step S2. As shown in FIG. 7, in the glaze layer forming step S2, the glaze layer 20 is formed on the substrate 10 (the first main surface 10a). In the glaze layer forming step S2, first of all, a paste containing glass is applied on the first main surface 10a. Secondly, the paste applied is heated. Thus, the glaze layer 20 is formed by evaporation of a solvent in the paste and coupling of the glass in the paste.

The metal layer forming step S3 is performed after the glaze layer forming step S2. FIG. 8 shows a cross-sectional view of the metal layer forming step S3. As shown in FIG. 8, in the metal layer forming step S3, a metal layer 33 is formed on the glaze lay 20. The metal layer 33 is formed by applying a paste containing a material (for example, silver particles) forming the metal layer 33 on the glaze layer 20 and sintering the paste.

The metal layer patterning step S4 is performed after the metal layer forming step S3. FIG. 9 shows a cross-sectional view of the metal layer patterning step S4. As shown in FIG. 9, in the metal layer patterning step S4, the metal layer 33 is patterned and becomes the wiring layer 30. In the metal layer patterning step S4, first of all, a resist pattern is formed on the metal layer 33. The resist pattern is formed by applying a photosensitive resin material on the metal layer 33, and exposing and developing the applied photosensitive resin material. The resist pattern includes an opening portion, and the metal layer 33 is exposed from the opening portion. Secondly, the resist pattern is used as a mask to perform wet etching on the part of the metal layer 33 exposed from the resist pattern. Accordingly, the metal layer 33 is patterned and becomes the wiring layer 30.

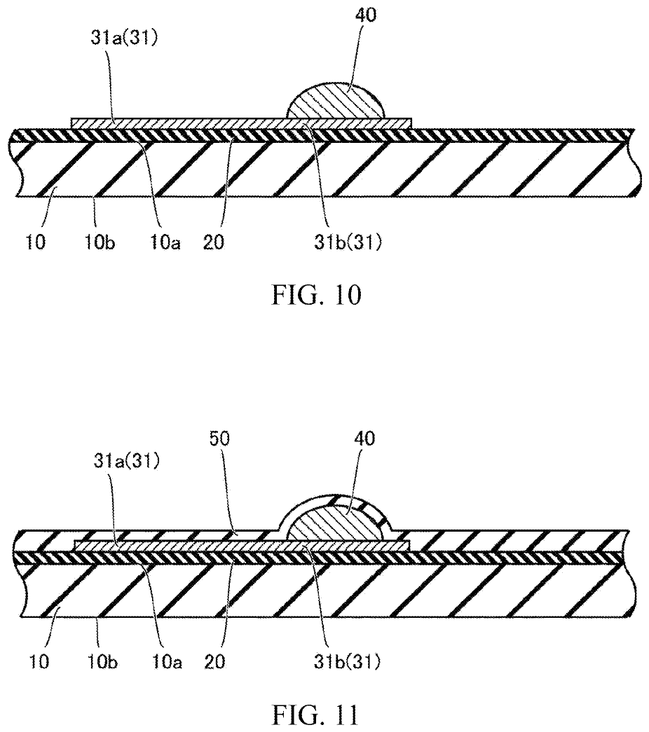

The heat generator forming step S5 is performed after the metal layer patterning step S4. FIG. 10 shows a cross-sectional view of the heat generator forming step S5. As shown in FIG. 10, in the heat generator forming step S5, the heat generator 40 formed on the glaze layer 20 while overlapping the protrusion 31b and the front end 32a. The heat generator 40 is formed by applying a paste containing a material (for example, glass and RuO₂ particles) forming the heat generator 40 on the glaze layer 20 to overlap the protrusion 32b and the front end 32a and sintering the paste.

The protection glass forming step S6 is performed after the heat generator forming step S5. FIG. 11 shows a cross-sectional view of the protection glass forming step S6. As shown in FIG. 11, in the protection glass forming step S6, the protection glass 50 is formed on the glaze layer 20 to cover the wiring layer 30 and the heat generator 40. The protection glass 50 is formed by applying a paste containing glass on the glaze layer 20 to cover the wiring layer 30 and the heat generator 40 and sintering the paste.

The single-chip step S7 is performed after the protection glass forming step S6. In the single-chip step S7, single-chip is performed by irradiating with such as laser to cut the substrate 10, the glaze layer 20 and the protection glass 50 to form a plurality of thermal print heads 100. With the above, the thermal print head 100 having the structure shown in FIG. 1 to FIG. 5 can be obtained.

### (Effects of Thermal Print Head 100)

Compared to a thermal print head of a comparison example, the effects of the thermal print head 100 are described below. The thermal print head of the comparison example is set as a thermal print head 100A.

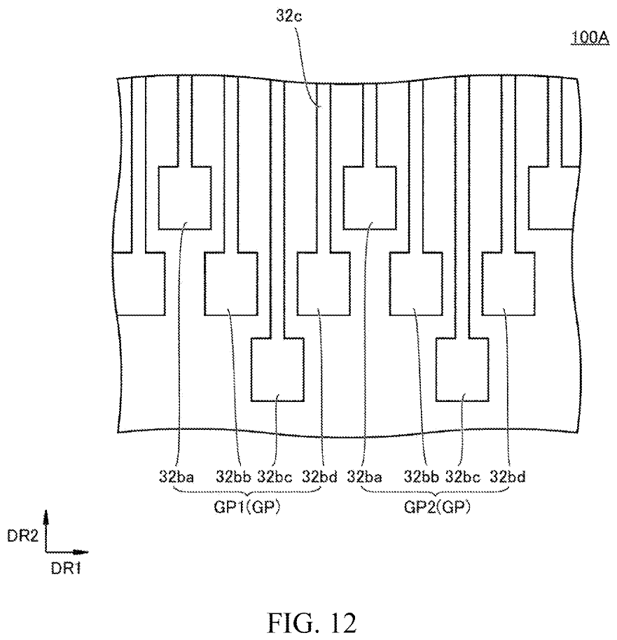

FIG. 12 shows an enlarged plan view of the thermal print head 100A. As shown in FIG. 12, in the thermal print head 100A, the second bonding pad 32bb and the fourth bonding pad 32bd are disposed between the first bonding pad 32ba and the third bonding pad 32bc in the second direction DR2. Apart from the above, the configuration of the thermal print head 100A is common with that of the thermal print head 100.

In the thermal print head 100A, the second bonding pad 32bb and the fourth bonding pad 32bd are disposed in opposite in the first direction DR1, and the lead wiring portion 32c connected to the third bonding pad 32c passes through between the second bonding pad 32bb and the fourth bonding pad 32bd. Thus, in the thermal print head 100A, if the pitch of the bonding pad 32b is narrowed (that is, the pitch P is reduced), a width of the lead wiring portion 32c is inevitably reduced.

As described above, the wiring layer 30 is formed by performing wet etching on the metal layer 33 in the metal layer patterning step S4. Because the wet etching is performed isotropically, the lead wiring portion 32c is thinned if the width of the lead wiring portion 32c is reduced, such that the lead wiring portion 32c can break sometimes. Thus, it is difficult to reduce the pitch P according to the thermal print head 100A.

On the other hand, in the thermal print head 100, the lead wiring portion 32c connected to the second bonding pad 32bb of the first group GP passes through between the first bonding pad 32ba of the first group GP1 and the third bonding pad 32bc of the first group GP1, and the lead wiring portion 32c connected to the fourth bonding pad 32bd of the first group GP1 passes through between the third bonding pad 32bc of the first group GP1 and the first bonding pad 32ba of the second group GP2.

However, in the thermal print head 100, the first bonding pad 32ba of the first group GP1 and the third bonding pad 32bc of the first group GP1 are not disposed in opposite in the first direction DR1, and the third bonding pad 32bc of the first group GP1 and the first bonding pad 32ba of the second group GP2 are not disposed in opposite in the first direction DR1. Thus, in the thermal print head 100, the lead wiring portion 32c does not pass through between two bonding pads 32b disposed in opposite in the first direction DR1, and so the width of the lead wiring portion 32c can be ensured even if the pitch P is reduced. For example, in the thermal print head 100, the lead wiring portion 32c can be extended to regions indicated by the dotted lines in FIG. 5. As a result, according to the thermal print head 100, even if the pitch P is reduced, the lead wiring portion 32c is not easily broken during wet etching, and the pitch between the bonding pads 32b can be narrowed (for example, the pitch P can be set to less than about 70 μm).

The number of bits of outputs of current driver ICs is mostly a multiple of 4 (64-bit, or 128-bit). In the thermal print head, since four bonding pads 32b are arranged as one cycle, current driver ICs can be easily handled.

When the wiring layer 30 is formed of silver, compared to when the wiring layer 30 is formed of gold, the thickness T is sometimes increased. When the thickness T is increased, the amount of etching in a horizontal direction (a direction perpendicular to a thickness direction of the metal layer 33) in wet etching in the metal layer patterning step S4 is increased, and the lead wiring portion 32c can be thinned easily. In the thermal print head 100, because the width of the lead wiring portion 32c can be ensured, narrowing of the pitch between the bonding pads 32b can be achieved even if the thickness T is increased. Moreover, by forming the wiring layer 30 by silver, compared to when the wiring layer 30 is formed of gold, manufacturing costs of the thermal print head 100 can be reduced.

### Variation Examples

In the description above, although an example in which four bonding pads 32b are used as a group and such group is periodically arranged along the first direction DR1, and the plurality of bonding pads 32b are arranged into three rows along the first direction DR1, the arrangement of the plurality of bonding pads 32b is not limited such example. If the lead wiring portion 32c does not pass through between two bonding pads 32b disposed in opposite in the first direction DR1, a group including five or more bonding pads 32b can also be arranged periodically along the first direction, and the plurality of bonding pads 32b can also be arranged in four or more rows along the first direction DR1. However, as shown in the example in FIG. 1 to FIG. 5, by arranging the plurality of bonding pads 32b in three rows along the first direction DR1, an increase in a size of the thermal print head 100 in the second direction DR2 can be suppressed.

### Notes

The embodiments include the following configurations.

### Note 1

A thermal print head, comprising:
a substrate;
a glaze layer, disposed on the substrate; and
a wiring layer, disposed on the glaze layer, wherein
the wiring layer includes a plurality of bonding pads,
the plurality of bonding pads are divided into a plurality of groups,
each of the plurality of groups includes a first bonding pad, a second bonding pad, a third bonding pad and a fourth bonding pad,
a first group of the plurality of groups is adjacent to a second group of the plurality of groups along a first direction,
the second bonding pad of the first group is located between a center of the first bonding pad of the first group and a center of the third bonding pad of the first group along the first direction,
the fourth bonding pad of the first group is located between the center of the third bonding pad of the first group and a center of the first bonding pad of the second group along the first direction, and
the third bonding pad is disposed between the first bonding pad, the second bonding pad, and the fourth bonding pad along a second direction perpendicular to the first direction.

### Note 2

The thermal print head according to note 1, wherein a thickness of the wiring layer is between about 3 μm and about 10 μm.

### Note 3

The thermal print head according to note 1 or 2, wherein a pitch between two adjacent bonding pads of the plurality of bonding pads along the first direction is between about 30 μm and about 70 μm.

### Note 4

The thermal print head according any one of notes 1 to 3, wherein a material of the wiring layer comprises silver.

Embodiments of the disclosure are as described above; however, various modification may be made to the embodiments. Moreover, the disclosure is not limited to the embodiments described above. The scope of the present disclosure is represented by way of the claims, and is intended to cover all equivalent meanings and variations made within the scope accorded with the claims.

1. A thermal print head, comprising:
a substrate;
a glaze layer, disposed on the substrate; and
a wiring layer, disposed on the glaze layer, wherein
the wiring layer includes a plurality of bonding pads,
the plurality of bonding pads are divided into a plurality of groups,
each of the plurality of groups includes a first bonding pad, a second bonding pad, a third bonding pad and a fourth bonding pad,
a first group of the plurality of groups is adjacent to a second group of the plurality of groups along a first direction,
the second bonding pad of the first group is located between a center of the first bonding pad of the first group and a center of the third bonding pad of the first group along the first direction,
the fourth bonding pad of the first group is located between the center of the third bonding pad of the first group and a center of the first bonding pad of the second group along the first direction, and
the third bonding pad is disposed between the first bonding pad, the second bonding pad, and the fourth bonding pad along a second direction perpendicular to the first direction.

2. The thermal print head of claim 1, wherein a thickness of the wiring layer is between about 3 μm and about 10 μm.

3. The thermal print head of claim 1, wherein a pitch between two adjacent bonding pads of the plurality of bonding pads along the first direction is between about 30 μm and about 70 μm.

4. The thermal print head of claim 1, wherein a material of the wiring layer comprises silver.

5. The thermal print head of claim 2, wherein a material of the wiring layer comprises silver.

6. The thermal print head of claim 3, wherein a material of the wiring layer comprises silver.
